(19) United States
(12) Patent Application Publication
(10) Pub. No.: US 2006/0034181 A1
(43) Pub. Date: Feb. 16, 2006

(54) Network system and supervisory server control method

(75) Inventors: Yasuo Noguchi, Kawasaki (JP); Riichiro Take, Kawasaki (JP); Masahisa Tamura, Kawasaki (JP); Yoshihiro Tsuchiya, Kawasaki (JP); Kazutaka Ogiwara, Kawasaki (JP); Arata Ejiri, Kawasaki (JP); Tetsutaro Maruyama, Kawasaki (JP); Minoru Kamoshida, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/082,957

(22) Filed: Mar. 18, 2005

(30) Foreign Application Priority Data
Aug. 16, 2004 (JP) 2004-236279

(51) Int. Cl. H04J 3/14; H04J 1/16; H04L 1/00; H04L 12/26; H04L 12/28; H04L 12/56

(52) U.S. Cl. 370/242; 370/218

(57) ABSTRACT

A network system which facilitates the task of replacing switches pertaining to a detected link failure. A server network is formed from a plurality of switches and links. The link state of each port on the switches is being monitored by a link-down detector, and a switch port that has entered a link-down state from a link-up state is identified as an inoperative port. Upon detection of such a link-down event, a function disabler disables link functions of specified ports of other switches in the switch group to which the switch having the inoperative port belongs, so that the servers on the network will change their setups all at once and continue the communication through new paths.

### CROSS-REFERENCE TO RELATED APPLICATIONS

This application is based upon and claims the benefits of priority from the prior Japanese Patent Application No. 2004-236279, filed on Aug. 16, 2004, the entire contents of which are incorporated herein by reference.

### BACKGROUND OF THE INVENTION

1. Field of the Invention

The present invention relates to a fault tolerant network system and a method for controlling a supervisory server therefor. More particularly, the present invention relates to a network system, as well as a supervisory server control method therefor, which detects a problem with a switch port and disables functions of one or more other ports.

2. Description of the Related Art

Redundancy has been widely used to realize fault tolerant networks. FIG. 18 shows an example of a conventional network with a dual redundant design. Specifically, the illustrated network is formed from one group of switches 911, 912, and 913 (shown on the left), another group of switches 914, 915, and 916 (shown on the right), and a plurality of servers 921 to 928. The switches 911 to 916 transport data traffic within the illustrated network, and the servers 921 to 928 respond to various service requests. It is assumed that the left-group switches 911 to 913 are activated to allow the servers 921 to 928 to communicate.

The redundant network of FIG. 18 provides the servers 921 to 928 with fault tolerant communication paths. Specifically, in the event of a network failure in, for example, the left-group switches 911 to 913, the servers 921 to 928 configure themselves to use instead the right-group switches 914 to 916, thus making it possible to continue the communication. To implement this feature, the servers 921 to 928 are each equipped with two or more network interface cards (NICs) for multiple redundant network connections. Each server 921 to 928 assigns its IP address to one of the NICs. When a server 921 to 928 encounters a problem with its NIC or its corresponding cable or switch 911 to 916, that server reassigns its IP address to another NIC to work around the problem. This type of redundant system is disclosed in, for example, Japanese Patent Republication of PCT No. 5-506553 (1993).

FIG. 19 shows an example situation where a conventional server has changed its NIC setup. Specifically, the left-most server 921 has enabled its right NIC, due to a link failure detected at the left NIC.

Conventional servers, however, are unable to detect some class of problems with their network. FIG. 20 shows an example situation where the top-most switch 911 experiences a failure in providing links between two switches 912 and 913. Since the servers 921 to 928 can detect only a local failure in the nearest network portion directly coupled to their NICs, none of them notice the link failure at the switch 911.

There are two kinds of failure detection functions implemented in the servers 921 to 928. One method is that each individual server watches its network links. Another method is that one server issues a ping command to another server, where the “ping” means “Packet Internet Grouper,” a command for verifying connectivity between two computers on a network. The former method can be implemented as part of network driver software and works faster than the latter method, because the latter method has to wait for a response from a remote server each time a ping command is issued.

Switches are sometimes organized in a multi-layer hierarchical structure, as in the example network of switches 911 to 916 shown in FIGS. 18 to 20. In that case, servers take the ping-based approach to avoid the problem discussed in FIG. 20. See, for example, Japanese Unexamined Patent Publication No. 2003-37600.

The above-described two methods, however, leave the decision of whether to switch the networks entirely to each individual server. Some servers still continue to use a switch having a faulty port as long as the port failure does not affect other ports that they are using. To replace the faulty switch with a new one, service engineers have to force those servers to change their network setups. From a maintenance standpoint, it is therefore desirable that all servers automatically switch the networks at a time.

Further, ping-based methods are not a preferable option for several reasons. First, it is necessary to set up each server to specify to which servers ping commands should be sent. Second, ping commands impose some amounts of extra traffic load and processing burden on the network and server processors, since many ping commands would be transmitted back and forth between a plurality of servers, depending on the network configuration. To make matters more complicated, the receiving servers are subject to failover; that is, they are designed as a dual redundant system which automatically switches to a protection subsystem when a failure occurs in the working subsystem.

### SUMMARY OF THE INVENTION

In view of the foregoing, it is an object of the present invention to provide a network system which facilitates the task of replacing switches pertaining to a detected link failure. It is another object of the present invention to provide a method for controlling a supervisory server for use in that network system.

To accomplish the first object stated above, the present invention provides a network system having multiple redundant communications paths. This network system involves a plurality of switches divided into a plurality of switch groups. Each switch has a plurality of ports for connection with other switches in a switch group, and a multi-layer network is formed from those switches. A link-down detector monitors link condition of each port on the switches to identify an inoperative port that has entered a link-down state from a link-up state. When such an inoperative port is found, a function disabler disables the link functions of specified ports of the switches in a switch group to which the switch having the inoperative port belongs.

To accomplish the second object, the present invention provides a method for controlling a supervisory server supervising multi-port switches that constitute a multi-layered network. According to this method, the link condition of each port of the switches is monitored to identify an inoperative port that has entered a link-down state from a link-up state. The switch ports are previously divided into a plurality of port groups. When such an inoperative port is found, a command is issued to the switches to disable link functions of all ports of a particular port group to which the identified inoperative port belongs.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of the present invention.

FIG. 2 is a conceptual view of a switch.

FIG. 3 is a block diagram of a server.

FIG. 4 shows an example structure of a network.

FIG. 5 shows a first example of how a network having a problem is displayed.

FIG. 6 shows a second example of how a network having a problem is displayed.

FIG. 7 is a flowchart of a process executed in a switch.

FIG. 8 shows an example of a port group management table.

FIG. 9 is a flowchart showing an example process that takes port groups into consideration.

FIG. 10 is a flowchart showing the details of S21 of FIG. 9.

FIG. 11 is a flowchart showing the details of step S24 of FIG. 9.

FIG. 12 shows a system where a supervisory server is deployed to detect and handle a network problem.

FIG. 13 illustrates the association between switches, ports, and groups.

FIG. 14 shows an example of a multiple switch port group database.

FIG. 15 shows an example of an intra-group position database.

FIG. 16 is a flowchart of a process executed by a supervisory server.

FIG. 17 shows an example hardware configuration of a supervisory server.

FIG. 18 shows an example of a conventional redundant network.

FIG. 19 shows an example situation where a conventional server changes its NICs.

FIG. 20 shows an example situation where conventional servers are unable to detect a problem with their network.

### DESCRIPTION OF THE PREFERRED EMBODIMENTS

Preferred embodiments of the present invention will be described below with reference to the accompanying drawings, wherein like reference numerals refer to like elements throughout. The description begins with an overview of the present invention and then proceeds to more specific embodiments of the invention.

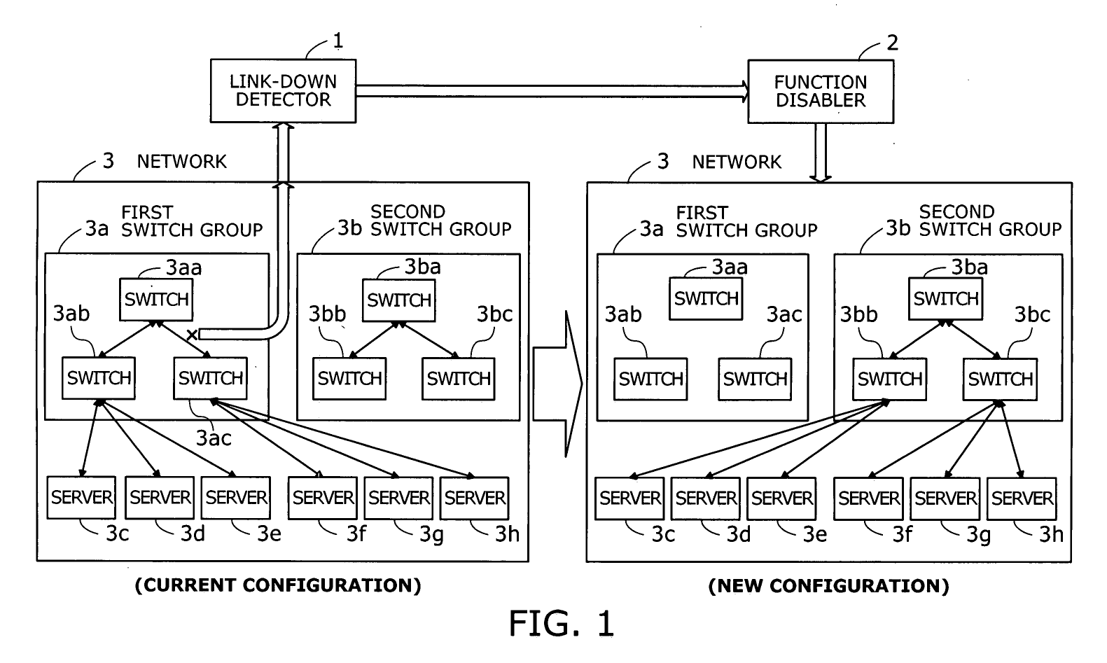

FIG. 1 is a conceptual view of the present invention. The illustrated network system has a link-down detector 1, a function disabler 2, and a network 3. The link-down detector 1 monitors every link in the network 3 in an attempt to find an inoperative port experiencing a problem with its link operation. The function disabler 2 disables link functions of all other ports related to the inoperative port. The network 3 provides electronic communications services, and the link-down detector 1, function disabler 2, and network 3 interact with each other.

More specifically, the network 3 accommodates two switch groups 3a and 3b and six servers 3c, 3d, 3e, 3f, 3g, and 3h. The switch groups 3a and 3b are collections of individual switches 3aa, 3ab, 3ac, 3ba, 3bb, and 3bc. The servers 3c to 3h respond to various service requests. The switch groups 3a and 3b communicate with those servers 3c to 3h.

The first switch group 3a consists of three switches 3aa, 3ab, and 3ac. Those switches 3aa to 3ac transport data traffic over the network 3, while interacting with each other. Likewise, the second switch group 3b consists of three switches 3ba, 3bb, and 3bc. Those switches 33ba to 3bc transport data traffic over the network 3, while interacting with each other.

Suppose, for example, that there is a problem with a communication path between two switches 3aa and 3ac in the first switch group 3a. This problem is detected by the link-down detector 1, thus causing the function disabler 2 to shut down the first switch group 3a. All servers 3c to 3h then find the disruption of communication paths involving the first switch group 3a and automatically select the second switch group 3b as new communication paths. Since the servers 3c to 3h make this change all at once, service engineers can readily begin troubleshooting in the first switch group 3a (e.g., replacing a faulty switch with a new unit). The following sections will present three specific embodiments of the present invention.

### First Embodiment

This section describes a first embodiment of the invention, in which a switch that has detected a link-down event in its own port forcibly disables other port links so as to propagate the link-down state to other switches belonging to the same switch group.

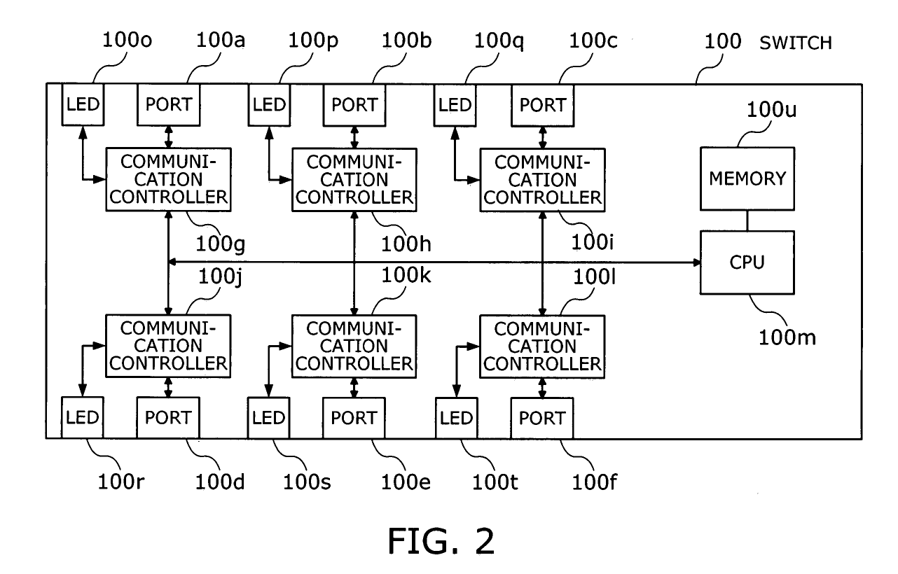

FIG. 2 is a conceptual view of a switch. This switch 100 has the following elements: ports 100a, 100b, 100c, 100d, 100e, and 100f; communication controllers 100g, 100h, 100i, 100j, 100k, and 1001; a central processing unit (CPU) 100m; light-emitting diode (LED) indicators 100o, 100p, 100q, 100r, 100s, and 100t; and a memory 100u.

The ports 100a to 100f are interface points where the switch 100 receives incoming electronic signals and transmit outgoing electronic signals under prescribed conditions. The communication controllers 100g to 100l control data flow inside the switch 100. Specifically, they inform the CPU 100m of a link-down event that has occurred at their corresponding ports in active use. They also disable a port link when so requested by the CPU 100m.

The CPU 100m manages the state of each individual port. Specifically, a port state of “1” means that the port is operating correctly, while a port state of “0” denotes that the port is inoperative. The ports are divided into groups, and the CPU 100m has a predetermined rule for disabling all ports belonging to a group when one of its member ports becomes inoperative. When applying this rule, the CPU 100m also records that event.

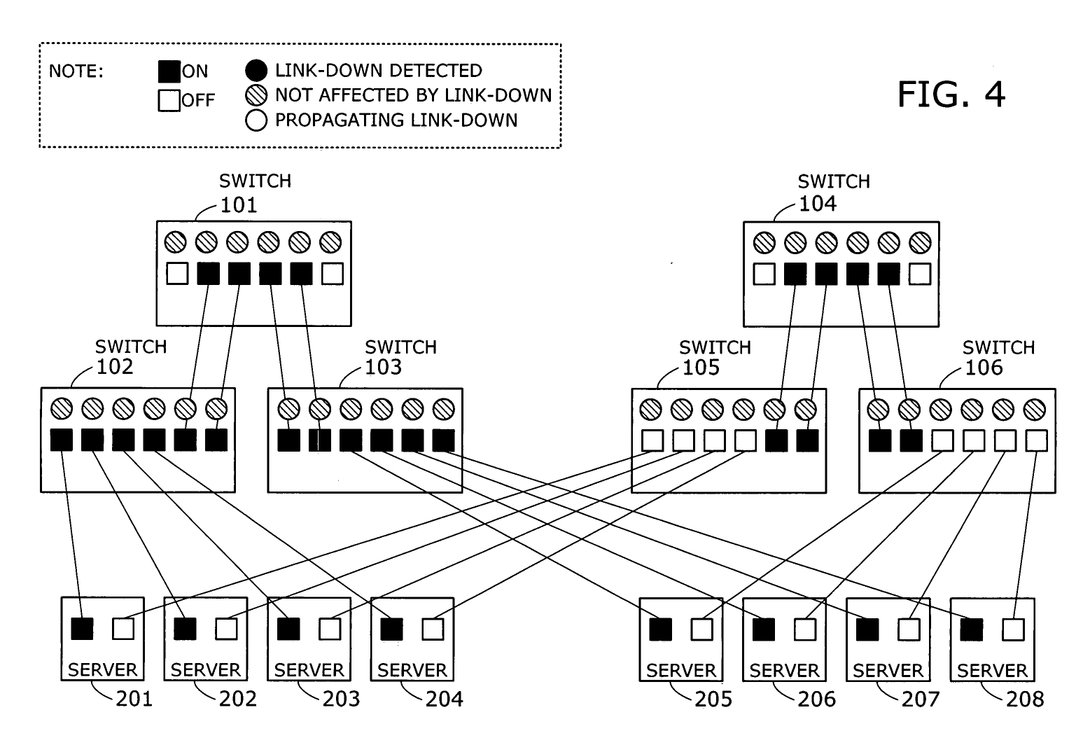

The LED indicators 100o to 100t are disposed next to the corresponding ports 100a to 100f to indicate their status with different lighting patterns (e.g., lit, unlit, flickering). As will be discussed later, FIGS. 4 to 6 show some specific examples of how the ports are controlled, where the state of each port is represented by a black dot (link-down detected), white dot (propagating link-down), or hatched dot (not affected). The ports 100a to 100f, communication controller 100g to 1001, CPU 100m, and LED indicators 100o to 100t interact with each other. The memory 100u stores programs and data that the CPU 100m executes and manipulates. All switches in the present description, including those that will be discussed in a later section, have a similar structure to this illustrated switch 100 of FIG. 2.

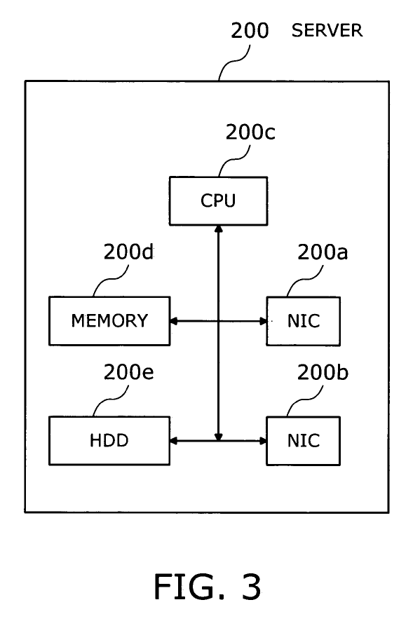

FIG. 3 is a block diagram of a server. This server 200 has two NICs 200a and 200b, a CPU 200c, a memory 200d, and a hard disk drive (HDD) 200e. The NICs 200a and 200b are interface cards used to connect the server 200 to the network, both of which are assigned the IP address of the server 200. The CPU 200c controls the server 200 in its entirety. The memory 200d temporarily stores software programs required for controlling the server 200, and the HDD 200e serves as storage for such programs. The NICs 200a and 200b, CPU 200c, memory 200d, and HDD 200e are interconnected by a bus. All servers appearing in this description, including those that will be discussed in later sections, have a similar structure to the illustrated server 200 of FIG. 3.

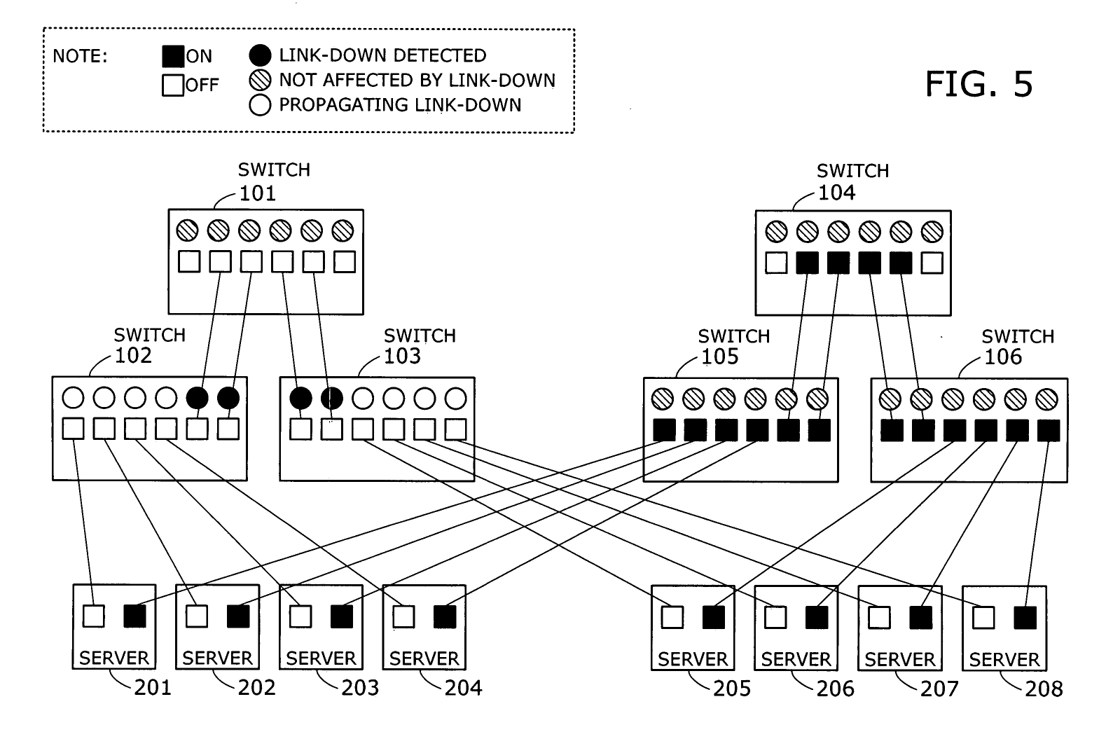

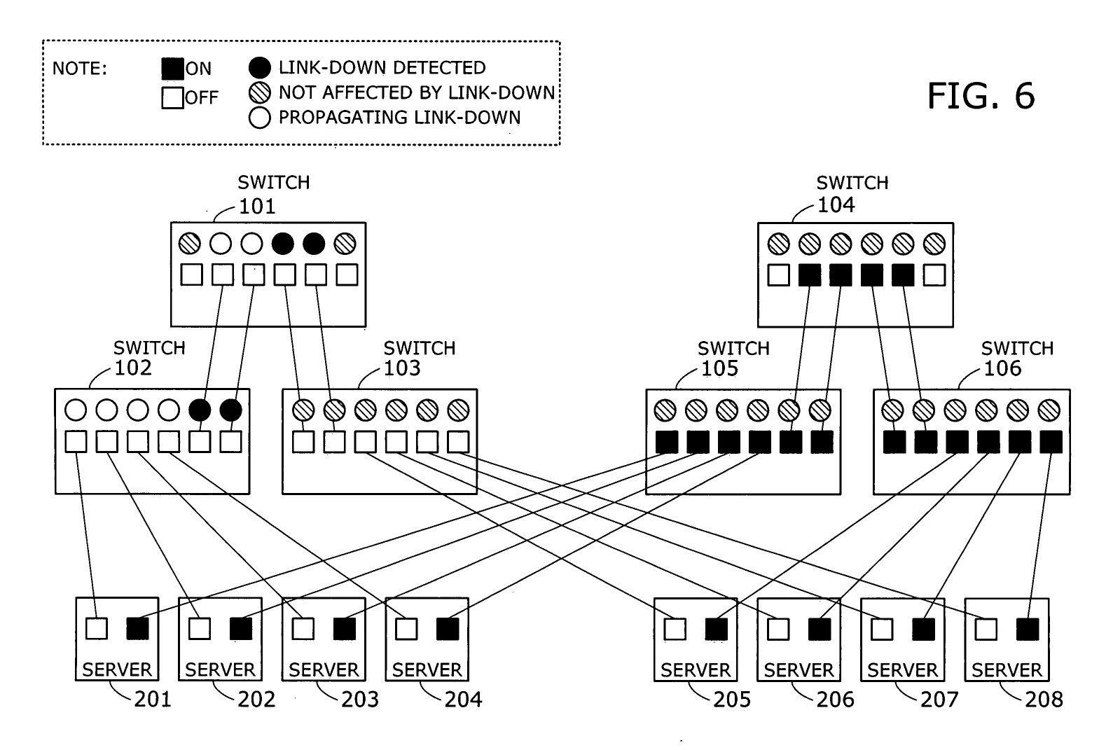

FIG. 4 shows an example structure of a switch network. This network is formed from eight servers 201 to 208 (collectively referred to by the reference numeral 200, where appropriate) and six switches 101 to 106 (collectively referred to by the reference numeral 100, where appropriate). The switches are divided into two groups: switches 101, 102, and 103 shown on the left half of FIG. 4, and switches 104, 105, and 106 shown on the right half. The switches 101 to 106 transport data traffic within a network, and the servers 201 to 208 respond to various service requests. It is assumed that the left-group switches 101 to 103 are currently activated to allow the servers 201 to 208 to communicate. With reference to FIGS. 5 to 6, the following paragraphs will now discuss how the switches 101 to 106 change from the initial states shown in FIG. 4.

FIG. 5 shows a first example of how a network having a problem is displayed. In the case that an active link goes down due to some problem in the network, the switch detects that link-down event and shuts off all links related to the network problem. This mechanism enables a network problem detected at one switch 100 in a multi-layer switch network to be recognized by all servers 200 potentially related to that problem. One switch 101 has a problem in the example of FIG. 5, and the link-down event propagates first to its subordinate switches 102 and 103 and then to all eight servers 201 to 208. This detection and propagation mechanism also works well in the case of a problem with NICs, cables, or the like.

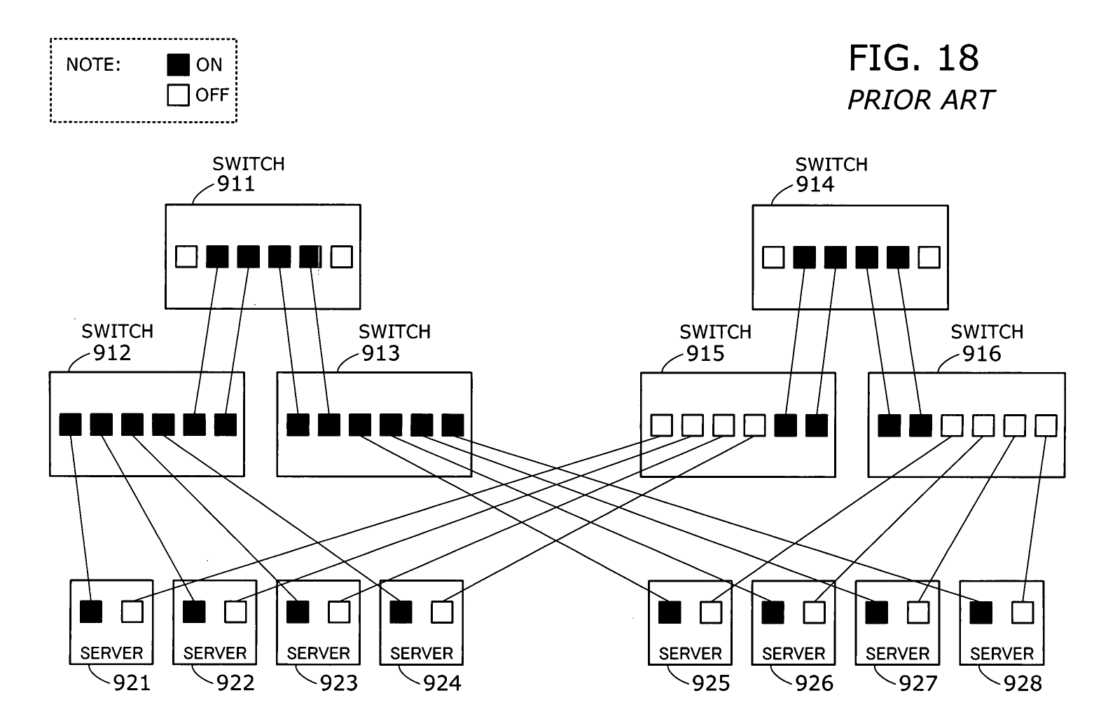

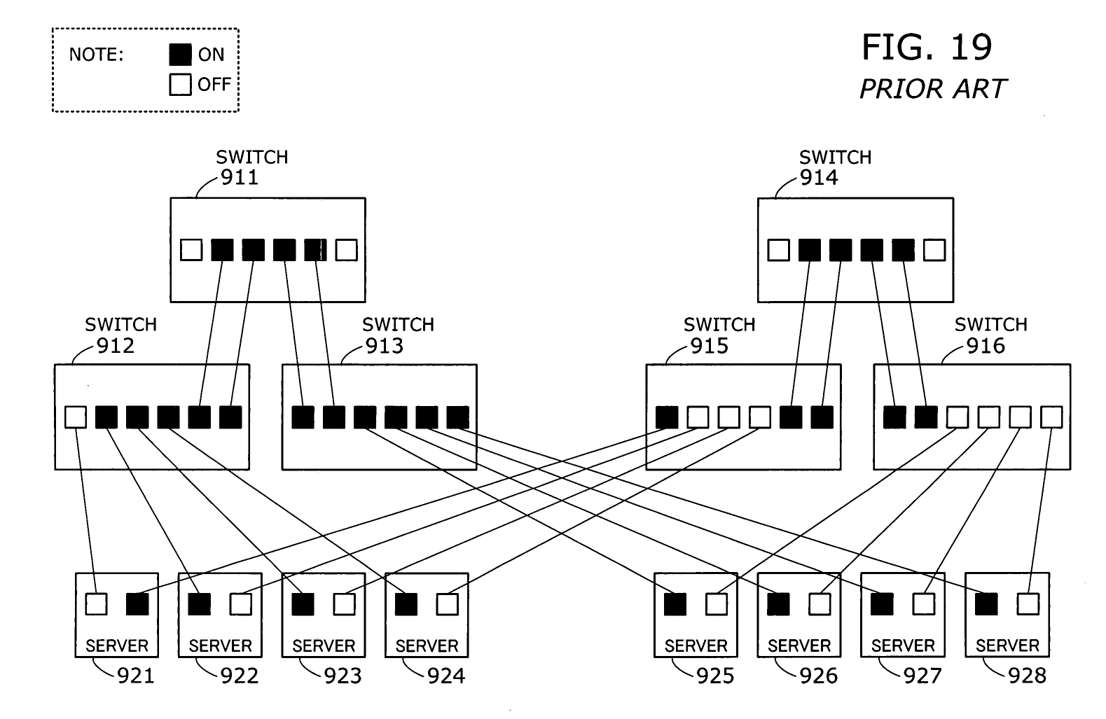

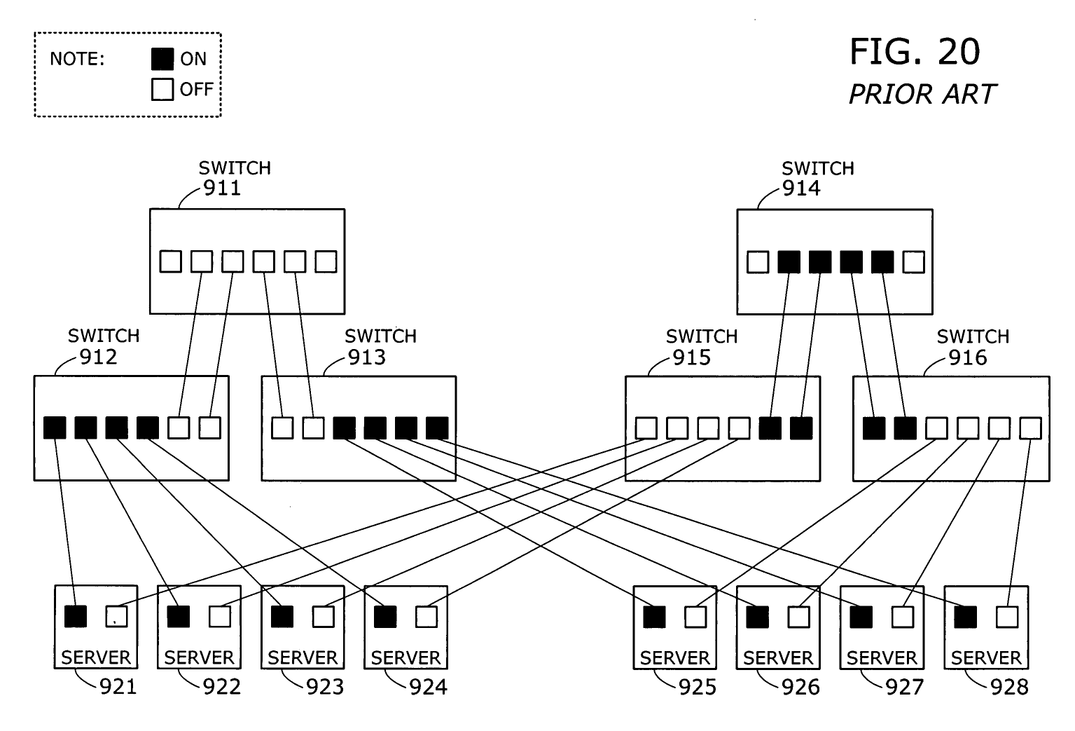

Recall that the conventional network system explained in FIGS. 18 to 20 can only reconfigure a particular switch 911 to 916 corresponding to the server that has detected a link-down state. According to the present embodiment, however, all servers 200 on the network perform switchover from the current group of switches 101 to 103 to another group of switches 104 to 106, thus allowing service engineers to replace the faulty switch immediately.

The present embodiment further provides an LED indicator for each port on a switch 100 to indicate whether it is where the link down was originally detected, or it has propagated the detected link-down event, or it is not affected by that link-down event. Service engineers would be able to locate an inoperative switch 100 by tracing the propagation paths from the original port. As mentioned earlier, FIG. 5 depicts the state of each port according to the following conventions: black dot (link-down detected), white dot (propagating link-down), and hatched dot (not affected). Note that, in some cases, a link-down state may be detected at two or more ports. In the example of FIG. 5, two switches 102 and 103 have detected problems at the ports linked to their parent switch 101, which implies that the switch 101 may be the real source of the problem.

FIG. 6 shows a second example of a network problem indicated by port state LEDs. Similarly to the case of FIG. 5, the propagation paths are traced from one switch 102 to another switch 101, and then to yet another switch 103. This means that the switch 103 is probably the origin of the problem.

In the way described above, the servers 200 can recognize a failure that has occurred in a remote switch, although their NICs are not directly connected to that switch. This is accomplished by propagating the original link-down event to other ports and links and thus permitting all involved servers to sense the presence of a problem as its local network link failure, without the need for using ping commands. Since the servers 200 involved in the network problem change their network setups all at once, the faulty switch is completely isolated from the network operation, and service engineers can readily replace it with a new unit.

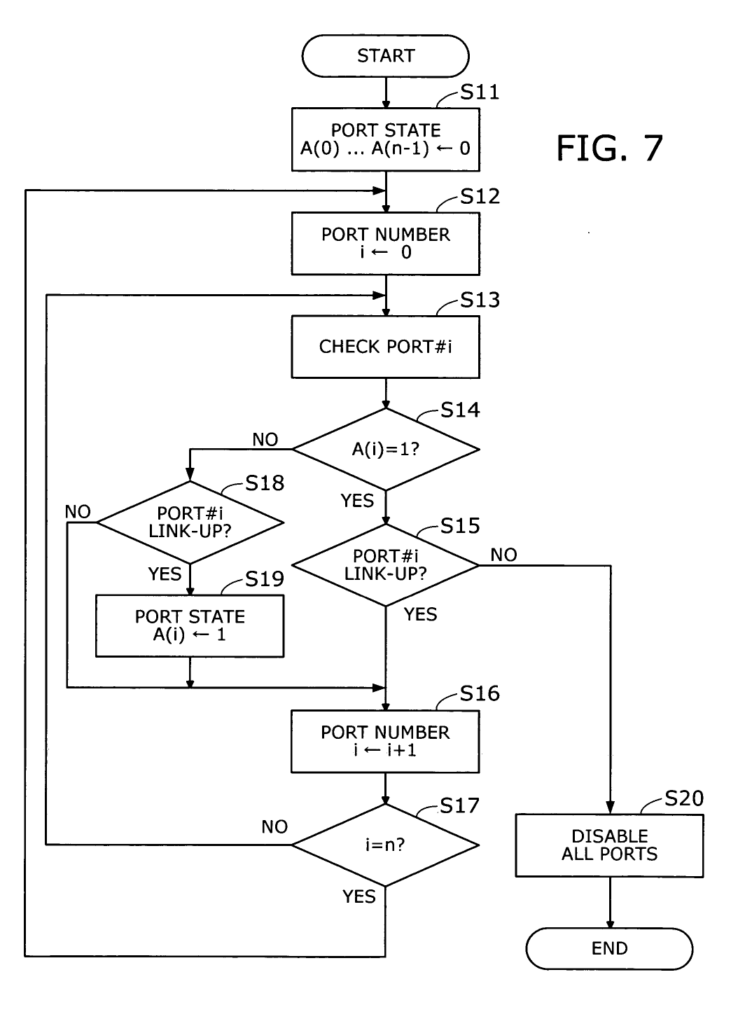

FIG. 7 is a flowchart of a process executed in each switch. It is assumed that the switch has n ports (n: natural number), each of which is designated by a port number i (i: integer ranging from 0 to n−1), and A(i) represents the state (e.g., ON or OFF, or link-up or link-down) of the i-th port (hereafter, port #i). For example, A(i)=1 means that port #i is in an ON state, while A(i)=0 means that it is in an OFF state. The process of FIG. 7 includes the following steps:
(S11) The switch initializes all port state variables A(0), A(1), . . . , A(n−1) to zero.
(S12) The switch sets i to zero, i.e., the smallest port number.
(S13) The switch begins a monitoring task with port #i.
(S14) If A(i)=1 (ON), the process advances to step S15.
If A(i)=0 (OFF), the process branches to S18.
(S15) The switch examines the actual state of port #i.

If port #i is really in an “ON” state in agreement with A(i)=1, the process advances to step S16 to check the next port. If port #i is actually in an “OFF” state as opposed to A(i)=1, the process proceeds to step S20 to shut down all ports.
(S16) The switch increments the port number i by one to proceed to the next cycle.
(S17) If all ports are checked, or i=n, the process goes back to step S12 to repeat the above steps. If there are unfinished ports, or i<n, the process returns to step S13 to select a next port to be checked.
(S18) If port #i is actually in an “ON” state, A(i) is not representing the state correctly. The process then proceeds to step S19 to correct A(i). If port #i is in an “OFF” state, in agreement with A(i), the process advances to step S16 to check the next port.
(S19) The switch sets A(i) to one.
(S20) The switch disables all ports, thus setting them to OFF state.

As can be seen from the above, all ports of a switch go down upon detection of a problem at one port. Since every switches in the network is configured as such, the link-down event propagates from the original inoperative switch to every other switch through port-to-port connections. As a result, every server is forced to change its network setup from the present network to an alternative network, so that all servers can communicate through new network connection paths. Now that the switches on the previously working network have all been stopped, service engineers can replace the inoperative switch at any time. Further, their LED indicators show how the link-down event has propagated, which aids service engineers to locate the origin of the problem.

### Second Embodiment

This section describes a second embodiment of the present invention, in which switches 100 are configured to disable a limited number of ports, rather than all ports, when they detects a link-down event. Specifically, ports on each switch 100 is divided into a plurality of groups. When one port goes down, the link-down state propagates to other ports that belong to the same group as the failed port. The membership of each port group is defined previously in a port group management table on the memory 100u.

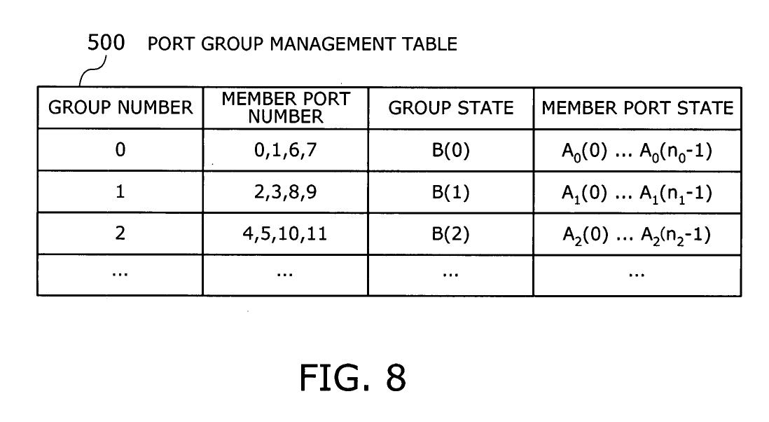

FIG. 8 shows an example of a port group management table. This port group management table 500 describes groups of ports on a switch 100, including state of each group. To serve as part of a network system, the switch 100 enables or disables port groups according to the table 500.

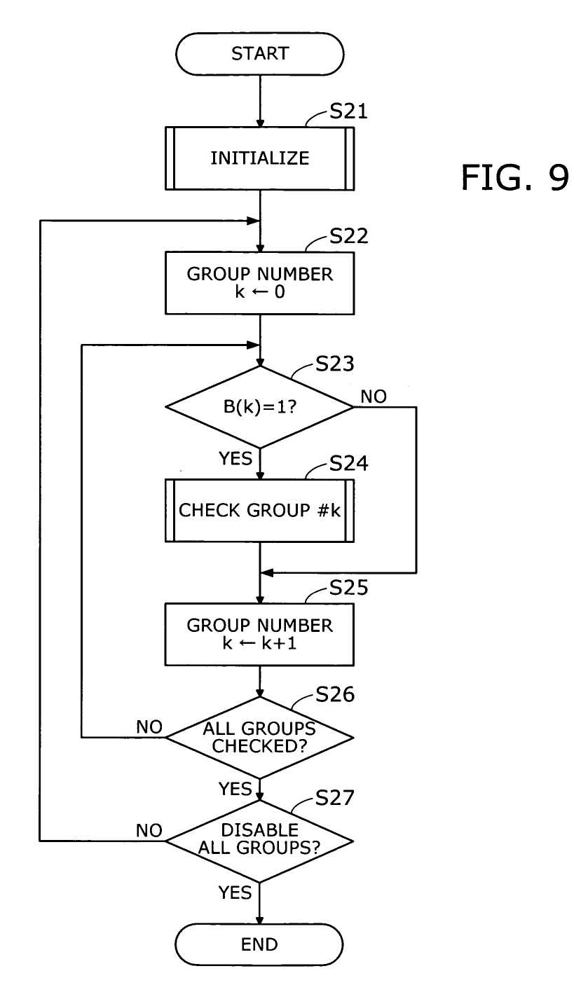

The illustrated port group management table 500 has the following data fields: “Group Number,” “Member Port Number,” “Group State,” and “Member Port State.” The group number field contains a group number representing a particular port group. The member port number field contains all port IDs representing the ports that belong to the group specified in the group number field. The group state field shows the state (ON or OFF) that the specified port group is supposed to be, and the member port state field shows the state (ON or OFF) of individual ports belonging to that group. Based on this port group management table 500, the switch 100 executes a process described in FIGS. 9 to 11.

FIG. 9 is a flowchart showing an example process that takes switch groups into consideration. Here, groups are designated by group numbers, k, which are integers starting from zero. The k-th group (hereafter, group #k) includes nₖ ports, where nₖ is a natural number. Each port is designated by a port number j, where j is an integer ranging from zero to nₖ−1. Aₖ(j) represents the state of the j-th port (hereafter, port #j) in group #k. For example, Aₖ(i)=1 means that port #i in group #k is in an ON state, and Aₖ(i)=0 means that it is in an OFF state. There are n groups, and B(k) represents the state of group #k (k: 0 . . . n−1). For example, B(k)=1 means that group #k is supposed to be in an ON state, and B(k)=0 means that it is supposed to be in an OFF state.

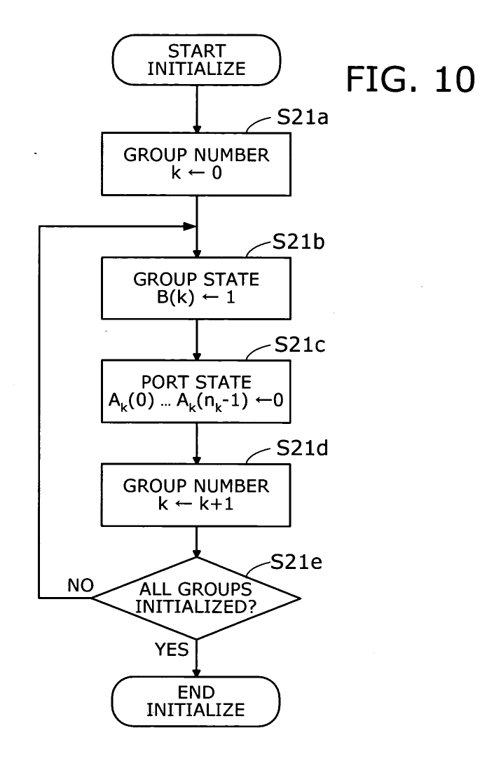

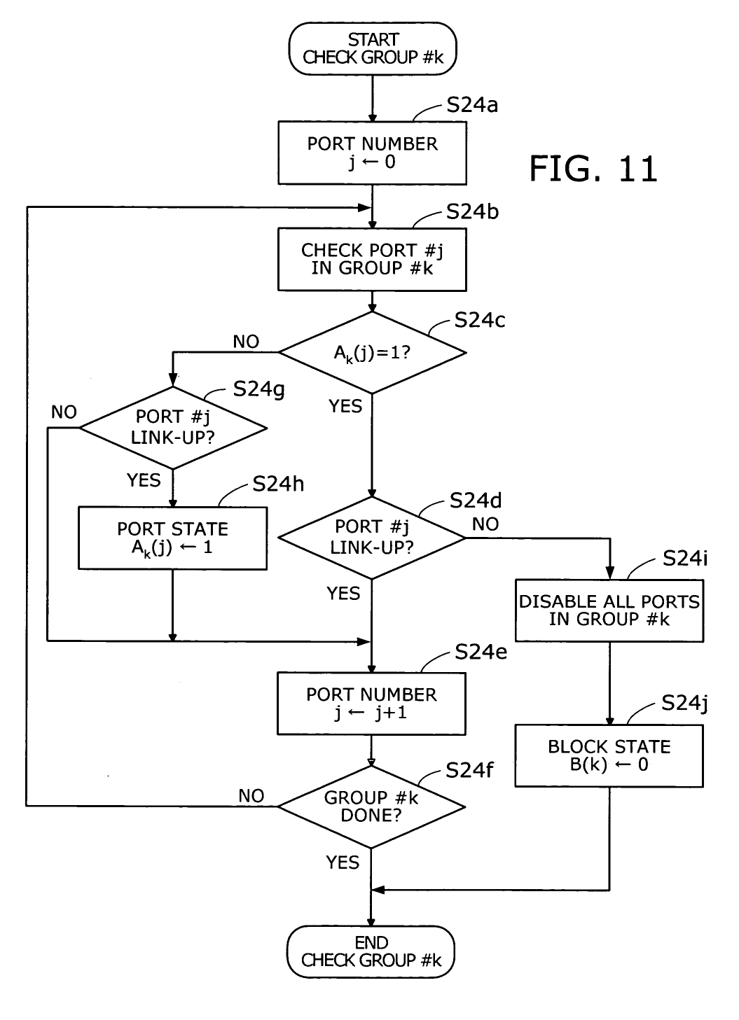

The process of FIG. 9 includes the following steps:
(S21) The switch (described later) initializes the variables representing group condition and member port condition. Details of this step will be described later with reference to FIG. 10.
(S22) The switch sets the group number k to zero (i.e., the smallest group number).
(S23) Group #k needs to be tested only when its group state B(k) is set to ON. If B(k)=1 (ON), the process advances to step S24. If B(k)=0 (OFF), the process skips to step S25.
(S24) The switch examines group #k. Details of this step will be described later with reference to FIG. 11.
(S25) The switch increments k by one to proceed to the next group.
(S26) If all groups are checked, the process advances to step S27. If not, the process returns to step S23.
(S27) Now that all groups have been checked, the switch then determines whether it needs to disable all groups. If so, the switch terminates the present process. If not, it goes back to step S22 to repeat the above steps.

FIG. 10 is a flowchart showing the details of S21 (“INITIALIZE”) of FIG. 9. This process includes the following steps:
(S21a) The switch sets k to zero (i.e., the smallest group number).
(S21b) The switch sets group state B(k) to zero.
(S21c) The switch sets port state Aₖ(0) . . . Aₖ(nₖ−1) to zero.
(S21d) The switch increments k by one to proceed to the next group.
(S21e) If all groups are initialized, the switch exits from this process. If not, it goes back to step S21b.

FIG. 11 is a flowchart showing the details of step S24 (“CHECK GROUP #k”) of FIG. 9. This process includes the following steps:
(S24a) The switch sets the port number j to zero (i.e., the smallest port number).
(S24b) The switch begins a monitoring task with port #j.
(S24c) If Aₖ(j)=1 (ON), the process advances to step S24d. If Aₖ(j)=0 (OFF), it branches to step S24g.
(S24d) The switch examines the actual state of port #j.

If port #j is really in an “ON” state, in agreement with Aₖ(j), the process advances to step S24e to check the next port. If, on the other hand, the port #j is actually in an “OFF” state as opposed to Aₖ(j)=1, the process proceeds to step S24i to shut down all ports belonging to group #k.
(S24e) The switch increments j by one to proceed to the next port.
(S24f) If all ports are checked, the switch exits from this process. If there are unchecked ports, it returns to step S24 to examine the next port.
(S24g) If port #j is actually in an “ON” state, Aₖ(j) is not representing the state correctly. The process then proceeds to step S24h to correct Aₖ(j). If port #j is really in an “OFF” state, in agreement with Aₖ(j), the process then proceeds to step S24e to check the next port.
(S24h) The switch sets the port state variable Aₖ(j) to one.
(S24i) The switch shuts down all ports belonging to group #k.
(S24j) The switch clears the group state B(k) to zero.

As can be seen from the above, all member ports of a group will go down upon detection of a problem with one port. Since all switches 100 constituting a network operate in this way, every server is forced to change its link setup from the present network to another network, so that all servers can communicate through new network connection paths. Now that the previously selected switches are all stopped, service engineers can readily replace the faulty switch with a new unit.

### Third Embodiment

This section describes a third embodiment which employs a supervisory server. Switches 100 have the functions of notifying the supervisory server of a link-down event that they have detected. In response to the problem notification, the supervisory server commands the switches 100 to disable a predetermined set of ports.

The use of a separate supervisory server to control switch ports enables the port groups to be defined across a plurality of switches 100. The following example assumes three port groups defined across three switches 100 each having twelve ports.

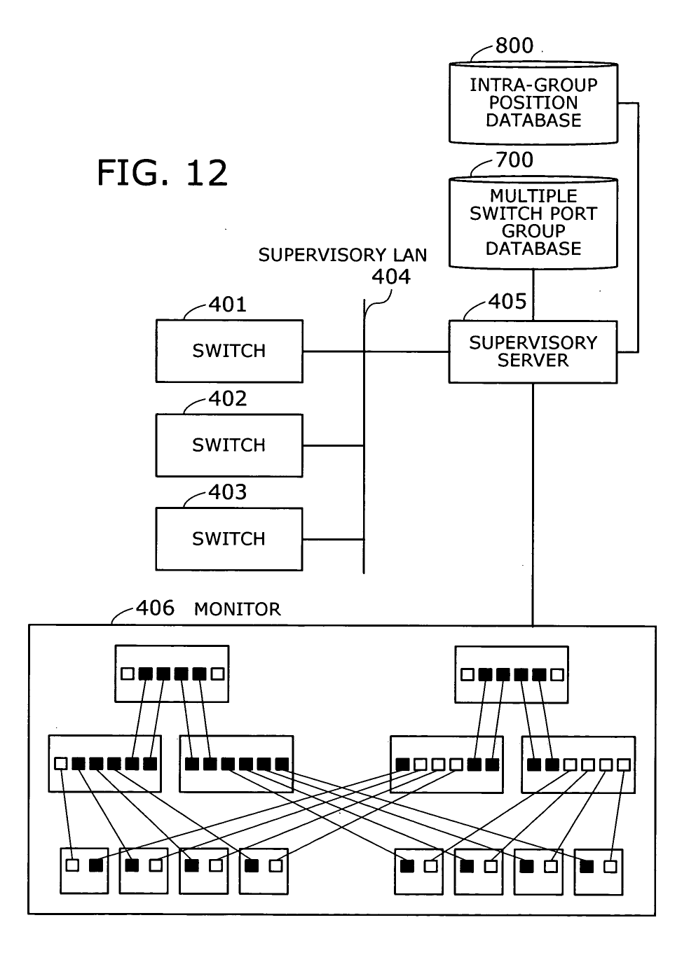

FIG. 12 shows a system where a supervisory server is deployed to detect a problem in the network. Specifically, the system includes switches 401, 402, and 403, a supervisory LAN 404, a supervisory server 405, a monitor 406, a multiple switch port group database 700, and an intra-group position database 800. The switches 401 to 403 have basically the same hardware configuration as that described in FIG. 2, except that the switches 401 to 403 in the third embodiment may not have LED indicators.

The supervisory LAN 404 is a network environment providing communications services using the Simple Network Management Protocol (SNMP) or the like. The supervisory server 405 collects information about network problems, and based on that information, it determines whether to enable or disable each port of the switches 401 to 403. The monitor 406 is used to display the processing result of the supervisory server 405. The multiple switch port group database 700 stores definitions of how to group the switch ports. The intra-group position database 800 gives an intra-group port number to each port, with which the ports are uniquely identified in their respective groups.

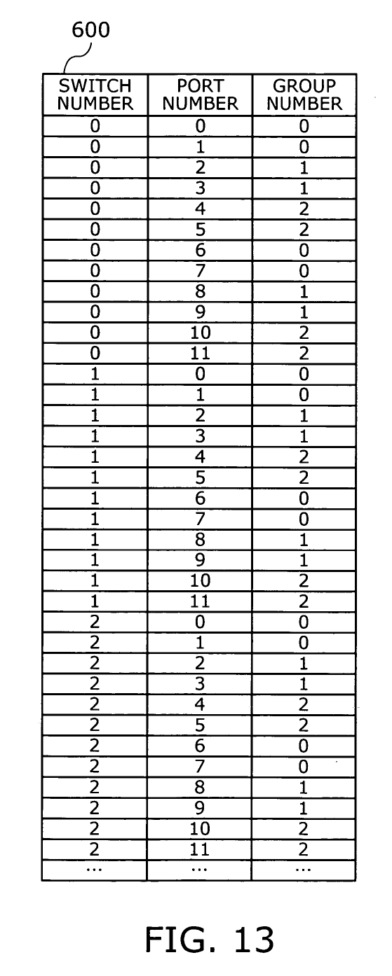

FIG. 13 illustrates the association between switches, ports, and groups. The table 600 shown in FIG. 13 has the following data fields for each table entry: “Switch Number,” “Port Number,” and “Group Number” The switch number field contains a number representing a particular switch. The port number field shows the port number of a port on that switch, and the group number field shows to which group that port belongs. Such group definitions are stored in the multiple switch port group database 700, together with some other information.

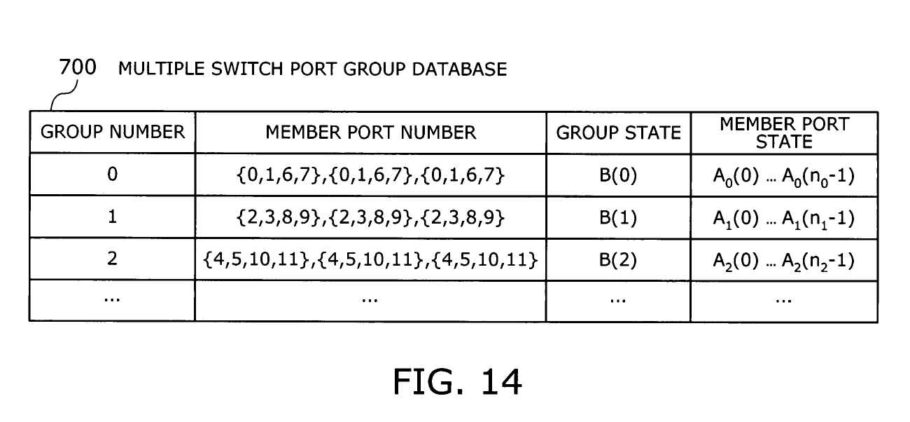

FIG. 14 shows an example of a multiple switch port group database. Switch port groups are defined across a plurality of switches 100. The illustrated multiple switch port group database 700 stores information about such groups of switch ports, including state of each group. To establish a network system, the supervisory server 405 enables or disables those port groups according to the table 700.

The multiple switch port group database 700 has the following data fields: “Group Number,” “Member Port Number,” “Group State,” and “Member Port State.” The group number field contains a particular group number. The member port number field shows a collection of port numbers representing the group membership, where the port numbers are separated by braces for each switch. More specifically, in the example of FIG. 14, each member port number field contains three sets of port numbers enclosed in braces. The first set belongs to switch #0, the second set to switch #1, and the third set to switch #2.

The group state field indicates the ON/OFF condition of ports belonging to each group. That is, the “ON” (or “1”) state of a specific group means that the ports in that group are supposed to be in a link-up state. The “OFF” (or “0”) state, on the other hand, means that the ports in that group are supposed to be disabled.

The member port state field indicates the ON/OFF condition of each individual port belonging to a specific group, The port state is expressed as Aₖ(m), where k is a group number, and m is an intra-group position number used to uniquely identify each member port within a group. Intra-group position number m is an integer ranging from zero to (nₖ−1), where nₖ is the total number of ports that constitute group #k.

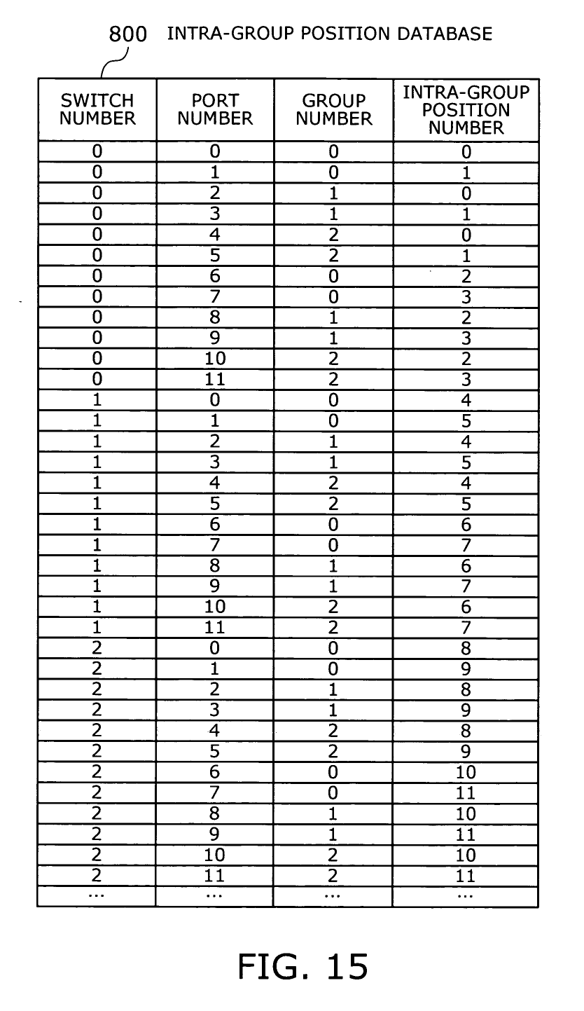

The intra-group position database 800 is employed to manage the intra-group position numbers mentioned above. By consulting this database 800, the supervisory server 405 can identify where each port is positioned in its group. FIG. 15 shows an example of the intra-group position database 800. This database 800 has the following data fields: “Switch Number,” “Port Number,” “Group Number,” and “Intra-Group Position Number.” The switch number field contains a number that represents a particular switch, and the port number field shows the port number of a port on that switch. The group number field indicates to which group that port belongs, and the intra-group position number field tells its position in the group.

The supervisory server 405 receives from switches a message that reports an event related to the condition of their ports, including port numbers of a specific switch 100, as well as a switch number representing the switch itself. Upon receipt of this event report message, the supervisory server 405 consults the intra-group position database 800 in an attempt to obtain a group number and an intra-group position number associated with the received switch number and port number.

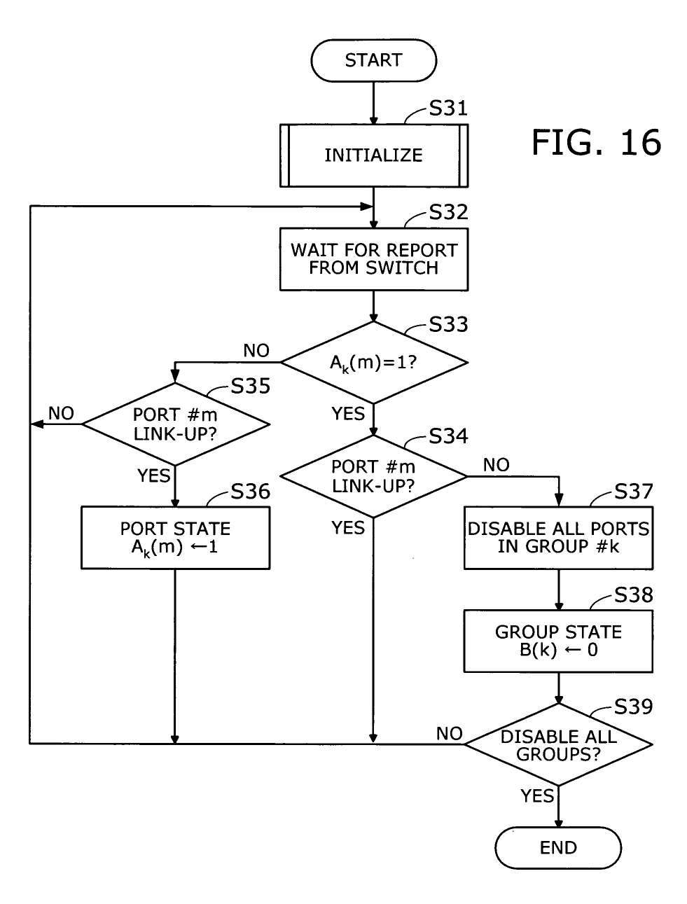

FIG. 16 is a flowchart specifically showing a process executed by the supervisory server 405. This process includes the following steps:
(S31) The supervisory server 405 initializes variables representing group state and member port state, in the same way as step S21 described in FIG. 9.
(S32) The supervisory server 405 waits for an event report message from switches 100.
(S33) If Aₖ(m)=1 (ON), the process advances to step S34. If Aₖ(m)=0 (OFF), it branches to step S35.
(S34) The supervisory server 405 examines the actual state of port #m. If port #m is really in an “ON” state, in agreement with Aₖ(m), the process then goes back to step S32 to check the next port. If port #m is actually in an “OFF” state as opposed to Aₖ(m)=1, the process proceeds to step S37 to shut down all ports belonging to group #k.
(S35) If port #m is actually in an “ON” state, Aₖ(m) is not representing the state correctly. The process then proceeds to step S36 to correct Aₖ(m). If port #j is really in an “OFF” state, in agreement with Aₖ(m), the process then returns to step S32 to be ready for another event.
(S36) The supervisory server 405 sets port state Aₖ(m) to one.
(S37) The supervisory server 405 shuts down all ports belonging to group #k.
(S38) The supervisory server 405 sets group state B(k) to zero.
(S39) Now that all groups have been examined, the supervisory server 405 then determines whether it needs to disable all groups. If so, the supervisory server 405 terminates the present process. If not, the process returns to step S32 to wait for another event.

As can be seen from the above, a port group can be defined across a plurality of switches constituting a network, and all member ports of a group will go down upon detection of a fault event occurred at one port of a switch. No mater how complex the network may be, the present network setup can be switched to another network automatically and flexibly. Since the previously selected switches are all stopped, service engineers can replace a faulty switch at any time. Also, the locations of ports that have detected a link-down event are displayed on a monitor 406, which enables the engineers to identify the faulty switch quickly.

While FIG. 13 has shown the case where a single switch assigns its ports to different groups, it would also be possible to form a separate port group for each switch. In other words, all ports on a single switch will have the same group number. This group setup method enables the supervisory server 405 to control the switch ports as in the first embodiment described in FIGS. 4 to 6.

### Hardware Platform and Program Storage Media

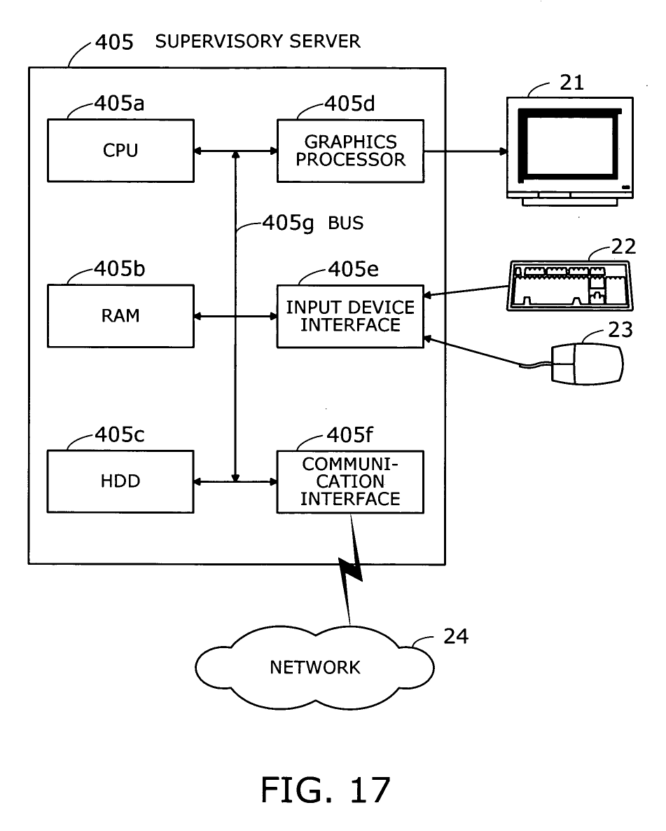

The supervisory server 405 described in the preceding section can be implemented on a hardware platform described below. FIG. 17 shows an example hardware configuration of a supervisory server. This supervisory server 405 has the following functional elements: a CPU 405a, a random access memory (RAM) 405b, an HDD 405c, a graphics processor 405d, an input device interface 405e, and a communication interface 405f.

The CPU 405a controls the entire computer system of the supervisory server 405, interacting with other elements via a common bus 405g. The RAM 405b serves as temporary storage for the whole or part of operating system (OS) programs and application programs that the CPU 405a executes, in addition to other various data objects manipulated at runtime. The HDD 405c stores program and data files of the operating system and various applications.

The graphics processor 405d produces video images in accordance with drawing commands from the CPU 405a and displays them on the screen of an external monitor unit 21 coupled thereto. The input device interface 405e is used to receive signals from external input devices, such as a keyboard 22 and a mouse 23. Those input signals are supplied to the CPU 405a via the bus 405g. The communication interface 405f is connected to a network 24, allowing the CPU 405a to exchange data with other computers (not shown) on the network 24.

A computer with the above-described hardware configuration serves as a platform for realizing the processing functions of the embodiments of present invention. The instructions that the supervisory server 405 is supposed to execute are encoded and provided in the form of computer programs. Various processing services are realized by executing those server programs on the supervisory server 405.

The server programs are stored in a computer-readable medium for use in the supervisory server 405. Suitable computer-readable storage media include magnetic storage media, optical discs, magneto-optical storage media, and solid state memory devices. Magnetic storage media include, among others, hard disk drives (HDD), flexible disks (FD), and magnetic tapes. Optical discs include, among others, digital versatile discs (DVD), DVD-RAM, compact disc read-only memory (CD-ROM), CD-Recordable (CD-R), and CD-Rewritable (CD-RW). Magneto-optical storage media include, among others, magneto-optical discs (MO).

Portable storage media, such as DVD and CD-ROM, are suitable for circulation of the server programs. The server computer stores server programs in its local storage unit, which have been previously installed from a portable storage media. By executing those server programs read out of the local storage unit, the server computer provides its intended services. Alternatively, the server computer may execute those programs directly from the portable storage media.

### CONCLUSION

According to the present invention, a link-down event at a particular port causes shutdown of other specified ports in the same switch group. This feature enables a dual redundant server network to perform automatic failover from the failed switch group to an alternative switch group. Since the faulty switch is immediately isolated from the network operation, service engineers can readily replace it with a new unit.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A network system having multiple redundant communications paths, comprising:
a plurality of switches divided into a plurality of switch groups, each switch having a plurality of ports, the switches in each switch group being connected with each other to form a multi-layer network;
link-down detection means for monitoring link condition of each port on the switches to identify an inoperative port that has entered a link-down state from a link-up state; and
function disabling means for disabling link functions of specified ports of the switches in a switch group to which the switch having the inoperative port belongs.

2. A switch having a plurality of ports for transporting data traffic, comprising:
link-down detection means for monitoring link condition of each port to identify an inoperative port that has entered a link-down state from a link-up state; and
function disabling means for disabling link functions of at least one of the ports other than the inoperative port identified.

3. The switch according to claim 2, wherein:
the plurality of ports are previously divided into a plurality of port groups; and
the function disabling means disables link functions of all ports of the port group to which the inoperative port belongs.

4. The switch according to claim 2, further comprising alarm generation means for generating a visual alarm to indicate which port has become inoperative.

5. The switch according to claim 4, wherein the alarm generation means comprises light-emitting devices each disposed adjacent to the ports to indicate the inoperative port by emitting a light.

6. A supervisory server for supervising switches constituting a multi-layered network, each switch having a plurality of ports, the supervisory server comprising:
link-down detection means for monitoring link condition of each port of the switches to identify an inoperative port that has entered a link-down state from a link-up state; and
function disabling means for issuing a command to the switches to disable link functions of all ports of a particular port group to which the identified inoperative port belongs, wherein the plurality of ports are previously divided into a plurality of port groups.

7. A method for controlling a supervisory server supervising switches that constitute a multi-layered network, each switch having a plurality of ports, the method comprising the steps of:
monitoring link condition of each port of the switches to identify an inoperative port that has entered a link-down state from a link-up state; and
issuing a command to the switches to disable link functions of all ports of a particular port group to which the identified inoperative port belongs, wherein the plurality of ports are previously divided into a plurality of port groups.

8. A supervisory server program for supervising switches that constitute a multi-layered network, each switch having a plurality of ports, the program causing a computer to function as:
link-down detection means for monitoring link condition of each port of the switches to identify an inoperative port that has entered a link-down state from a link-up state; and
function disabling means for issuing a command to the switches to disable link functions of all ports of a particular port group to which the identified inoperative port belongs, wherein the plurality of ports are previously divided into a plurality of port groups.

9. A computer-readable storage medium storing a supervisory server program for supervising switches that constitute a multi-layered network, each switch having a plurality of ports, the supervisory server program causing a computer to function as:
link-down detection means for monitoring link condition of each port of the switches to identify an inoperative port that has entered a link-down state from a link-up state; and
function disabling means for issuing a command to the switches to disable link functions of all ports of a particular port group to which the identified inoperative port belongs, wherein the plurality of ports are previously divided into a plurality of port groups.
